(19) United States
(12) Patent Application Publication
(10) Pub. No.: US 2011/0004927 A1
(43) Pub. Date: Jan. 6, 2011

(54) SYSTEM, METHOD AND PROGRAM PRODUCT FOR MEMBERSHIP BASED INFORMATION/FUNCTIONS ACCESS OVER A NETWORK

(76) Inventor: Michal Pawel Zlowodzki, Minneapolis, MN (US)

Correspondence Address: Michal Pawel Zlowodzki, Apt 718, 330 Oak Grove Street, Minneapolis, MN, 55403, US

(21) Appl. No.: 12/497,659

(22) Filed: Jul. 4, 2009

(51) Int. Cl. G06F 15/16; G06F 3/01; H04L 9/32; G06F 21/00

(52) U.S. Cl. 726/7; 715/751; 709/204

(57) ABSTRACT

A system, method and computer program product for membership based access over a network includes an external electronic community having a plurality of registered members. The external electronic community maintains a database of identities of the plurality of registered members. An electronic community has established at least one private area for registered members of the external electronic community and a connection with the external electronic community. Registered users of the electronic community request information access to the private area by supplying at least one unique identifier associated with a membership for membership verification and storage of the membership verification. The electronic community uses the connection to verify the unique identifier with the external electronic community. The registered users log into the electronic community. The electronic community uses information obtained during the logging to stored membership verification to enable information access to the private area.

### FEDERALLY SPONSORED RESEARCH OR DEVELOPMENT

Not applicable.

### REFERENCE TO SEQUENCE LISTING, A TABLE, OR A COMPUTER LISTING APPENDIX

Not applicable.

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office, patent file or records, but otherwise reserves all copyright rights whatsoever.

### FIELD OF THE INVENTION

The present invention relates generally to database programming. More particularly, the invention relates to a method and means for limiting access to information and/or certain functions in a website or discussion forum based on membership in an external community.

### BACKGROUND OF THE INVENTION

When users post information on the internet, they have limited control over who sees that information. In some cases a user may only want people with certain qualifications or credentials to be able to see what they post such as, but not limited to, physicians, lawyers, engineers, etc. In other cases a user may only want people who are members of a particular organization or group such as, but not limited to, a club, a class, a committee, etc. to see the posted information. In yet other cases, a user may wish that only employees from his workplace or a specific department of his workplace are able see the posted information. Therefore a solution that enables users to post information on a website or an electronic discussion forum knowing that only certain other users can see this information is desirable.

One prior art solution describes a method that provides assurance that an electronic pseudonym belongs to a member of a particular organization. This assurance comprises the steps of registering an organization with an authentication authority, distributing a membership token from the authentication authority to the organization and distributing the membership token to the members of that organization, registering the pseudonym with the authentication authority and associating the pseudonym with the organization using the membership token. The goal of this procedure is to establish a relationship between the pseudonym and the membership in the organization, thereby enabling a user of the pseudonym to communicate in an electronic forum or community as an authorized member of the organization.

An example of the operation of this prior art solution is presented in the following. A pseudonym is a username in an electronic case discussion forum, Website A in the present example. An organization is a defined group of people; the Orthopedic Trauma Association is used as the organization in this example. Authentication authority is provided by Website A. The user in the present example is a member of the Orthopedic Trauma Association, and the Orthopedic Trauma Association registers their members with Website A.

In the present example, Website A provides electronic tokens to the Orthopedic Trauma Association who in turn distributes these tokens to their members. A member of the Orthopedic Trauma Association receives the electronic token and registers a pseudonym (i.e., a username) with Website A. With the use of the electronic token, the pseudonym is associated with the Orthopedic Trauma Association. The user can now participate in the electronic forum on Website A and is recognized as a member of the Orthopedic Trauma Association.

However, the distribution of electronic tokens is cumbersome. Tokens must be provided to all of the members of the organization, although it is likely that not all of the members will participate. Also, the distribution of tokens requires time and work on the part of the website and the organization. If the recipient of the electronic token looses the token, which is presumably an email or letter, he must request another token or the website must repeat the active distribution of tokens time after time as likely not all of the members of the organization will sign up with the website and use the token right away. Furthermore, the organization must actively keep track of which of their members has already used the token to prevent the members of the organization from giving away an extra token to somebody who maybe is not a member of the organization.

In another prior art solution, a website is provided that is an internet community only for physicians. A user can only sign up as a physician. In order to prove that one is a physician, one must submit his medical license number. The website then verifies the medical license number. This solution generally prevents non-physicians from using the website; however, some users may be unwilling to share such personal information. Also, using this solution, a separate website must be created for each community that wishes to post information.

In yet another prior art solution to avoid public posting of information on a website, Facebook.com has a “poke” function where users must ask other users for permission to be able to see their profile or any information they post. The profile owner must agree before the user can access their profile. The disadvantage to this approach is that a profile owner that agrees to allow another user to see their profile does not know who the other user is; the other user can claim to be a doctor or a lawyer and the profile owner cannot verify that this is true. Furthermore, this is very cumbersome; as a user, the profile owner must actively agree or disagree to every single user that asks for access to their profile.

In view of the foregoing, there is a need for improved techniques for limiting access to information and/or certain functions in websites or electronic discussion forums that are easy for users and administrators to employ, accurately verify users' credentials and do not require users to provide a great deal of personal information.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is a flowchart illustrating an exemplary process for creating a user database in a website that can identify users as members of external communities, in accordance with an embodiment of the present invention;

FIG. 2 is a flowchart illustrating an exemplary process of a registered user using a website that enables users to limit access to information posted thereon, in accordance with an embodiment of the present invention;

FIG. 3 is a block diagram illustrating an exemplary network structure of external communities in a multi-level hierarchical system, in accordance with an embodiment of the present invention;

FIG. 4 is a block diagram illustrating an exemplary network structure of external communities in a many-to-many relationship system, in accordance with an embodiment of the present invention; and

FIG. 5 illustrates a typical computer system that, when appropriately configured or designed, can serve as a computer system in which the invention may be embodied.

Unless otherwise indicated illustrations in the figures are not necessarily drawn to scale.

### SUMMARY OF THE INVENTION

To achieve the forgoing and other objects and in accordance with the purpose of the invention, a method, system and computer program product for membership based access over a network is presented.

In one embodiment a method for membership based access over a network is presented. The method includes steps for accessing an electronic community having at least one private area for members of an external electronic community, steps for requesting information access to the private area and steps for supplying at least one unique identifier for verifying a membership in the external electronic community using a connection with the external electronic community. Another embodiment further includes steps for logging into the electronic community for the information access to the private area, wherein stored membership verification enables information access to the private area. Yet another embodiment further includes steps for enabling information access to a level of the private area including a multi-level hierarchical organization, and to higher levels.

In another embodiment a method for membership based access over a network is presented. The method includes steps of accessing an electronic community where the electronic community has established at least one private area for members of an external electronic community and a connection with the external electronic community. Information access to the private area is requested. At least one unique identifier associated with a membership in the external community is supplied for membership verification and storage of the membership verification, where the connection is used to verify the unique identifier with the external electronic community. Another embodiment further includes the step of logging into the electronic community for the information access to the private area by supplying login information for comparison to stored membership verification to enable information access to the private area. In another embodiment the electronic community has further established at least one public area in which information access is available to all registered users of the electronic community. In yet other embodiments the stored membership verification at least comprises a membership status and the login information obtained during the logging at least comprises a username for the electronic community. In yet another embodiment the private area includes a multi-level hierarchical organization for members of related external electronic communities. In still another embodiment a user with verified membership at a one of the related electronic communities is enabled with information access to a level of the private area associated with the one of the related electronic communities and to other higher levels.

In another embodiment a system for membership based access over a network is presented. The system includes means for maintaining identities of a plurality of registered members and means for establishing at least one private area for registered members of the maintaining means and a connection with the maintaining means, wherein registered users request information access to the private area by supplying at least one unique identifier for verifying a membership, and the establishing means uses the connection to verify the at least one unique identifier with the maintaining means, and stores membership verification information for the registered users. Another embodiment further includes means for enabling registered users for information access to the private area. Yet another embodiment further includes means for enabling information access to a level of the private area including a multi-level hierarchical organization, and to higher levels.

In another embodiment a system for membership based access over a network is presented. The system includes an external electronic community including a plurality of registered members, wherein the external electronic community maintains a database of identities of the plurality of registered members. An electronic community has established at least one private area for registered members of the external electronic community and a connection with the external electronic community. Registered users of the electronic community request information access to the private area by supplying at least one unique identifier associated with a membership in the external community for verifying the membership in the external electronic community. The electronic community uses the connection to verify the unique identifier with the external electronic community, and stores membership verification for the registered users. In another embodiment the registered users of the electronic community log into the electronic community for the information access to the private area. The electronic community compares information obtained during the logging to stored membership verification to enable information access to the private area. In yet another embodiment the electronic community has further established at least one public area in which information access is available to all registered users of the electronic community. In still other embodiments the stored membership verification at least includes a membership status and the login information obtained during the logging at least includes a username for the electronic community. In yet another embodiment the private area includes a multi-level hierarchical organization for registered members of related external electronic communities. In still another embodiment the registered users with verified membership at a one of the related electronic communities is enabled with information access to a level of the private area associated with the one of the related electronic communities and to other higher levels.

In another embodiment a computer program product for membership based access over a network is presented. The computer program product includes computer program code for accessing an electronic community where the electronic community has established at least one private area for members of an external electronic community and a connection with the external electronic community. Computer program code is provided for requesting information access to the private area. Computer program code is provided for supplying at least one unique identifier associated with a membership in the external community for membership verification and storage of the membership verification, where the connection is used to verify the unique identifier with the external electronic community. A computer-readable medium stores the computer program code. Another embodiment further includes computer program code for logging into the electronic community for the information access to the private area by supplying login information for comparison to stored membership verification to enable information access to the private area. In another embodiment the electronic community has further established at least one public area in which information access is available to all registered users of the electronic community. In yet other embodiments the membership verification at least comprises a membership status and the login information obtained during the logging at least includes a username for the electronic community. In yet another embodiment the private area includes a multi-level hierarchical organization for members of related external electronic communities. In still another embodiment a user with verified membership at a one of the related electronic communities is enabled with information access to a level of the private area associated with the one of the related electronic communities and to other higher levels.

Other features, advantages, and object of the present invention will become more apparent and be more readily understood from the following detailed description, which should be read in conjunction with the accompanying drawings.

### DETAILED DESCRIPTION OF THE PREFERRED EMBODIMENTS

The present invention is best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are numerous modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

The present invention will now be described in detail with reference to embodiments thereof as illustrated in the accompanying drawings.

Preferred embodiments of the present invention limit access to information and/or certain functions in a website, electronic discussion forum or other type of electronic community based on membership in an external community. In the present description the definition of an external community is any community that has a member database through which the member can be positively identified. External communities in preferred embodiments are primarily professional organizations that have member databases that comprise a username and a password for each of the members that the members use to access their own organizations' websites and other material. However, various different types of communities may be used in alternate embodiments of the present invention such as, but not limited to, students that are enrolled in a particular school or in a specific class, employees of a company, members of a club, etc. In the present description, the definition of information access is the ability to see, edit, delete, add or comment on information. The goal of preferred embodiments is to enable members of professional organizations and other communities to exchange information among themselves in an electronic forum that is unrelated to the websites and forums sponsored by those professional organizations.

Preferred embodiments provide a website, internet based discussion forum or other type of electronic community, herein referred to as a website, where anyone can sign up as a member of the main electronic community, and if a user is a member of a specific external community, for example, without limitation, a professional organization such as, but not limited to, the orthopedic trauma association, the user can verify himself as a member of the external community from within the website by entering the username and password that is stored in the member database of the external community after a connection to the external community database is established. Once the user has entered his username and password, it is stored in his personal profile in the database of the website that he is a member of this particular external community. After his profile reflects this, the user can post information that only other members of the external community can access and view information posted by other members of that external community. Using a preferred embodiment of the present invention, a user may post a question on a website and limit the access to the question to a specific external community, for example, without limitation, Orthopedic Trauma Association members, and know that this question will only be visible to users that have verified themselves as members of this group. Membership of other users in a specific organization or profession tells a user who wants to post a question on a website something about the other users' credentials since specific organizations or professions may have certain membership criteria.

In preferred embodiments of the present invention members of an external community are already registered in a member database of that external community. Logging on to the database of the external community from an outside website gives users the option to verify themselves as members of that external community. This is in contrast to the prior art solution that verifies users as a member of a particular community using a fairly cumbersome token distribution approach.

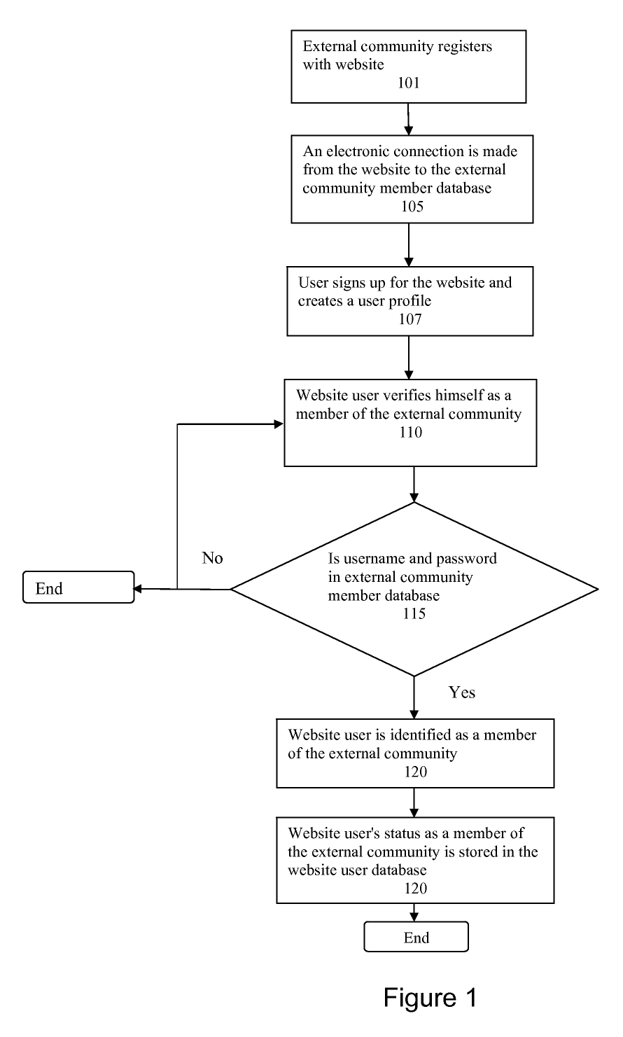

FIG. 1 is a flowchart illustrating an exemplary process for creating a user database in a website that can identify users as members of external communities, in accordance with an embodiment of the present invention. The website comprises a main electronic community public area where any user may post and access information and private areas with limited access where only verified members of external communities of the particular community may post and access information. In the present embodiment, the process begins at step 101 where an external community registers with the website. In step 105, with permission from the external community, an electronic connection from the website is then established with a member database of the external community that comprises at least a username or other unique identifier, such as, but not limited to, an email address or professional license or registration number, etc., and a password for each member of the external community assuming that such a member database exists or just one or a combination of multiple unique identifiers such as a professional license or registration number with or without a password. In step 107 the user signs up with the website and creates a user profile.

Users of the external community can sign up for the website and post questions or information with the main electronic community that all other users of the main electronic community can view and answer. However, if a user is a member of the external community, the user may wish that the questions and information that he posts are only visible to other members of the external community. In order to achieve this, the website enables the website user to verify himself as a member of the external community in a one-time procedure by logging on to the member database of the external community in step 110. In the present embodiment, the user creates a user profile and verifies himself by entering the username and password that is assigned to him in the member database of the external community. However, in alternate embodiments the user may verify himself using various different means that positively identify the user such as, but not limited to, entering an email address or professional license or registration number, or any other unique user identifier. It is determined if the username and password entered by the user are in the member database of the external community in step 115. Some embodiments may give the user multiple opportunities to correctly enter his username and password, while others may give the user only one opportunity. If the username and password are not in the member database and the user has at least one opportunity remaining to enter his username and password, the process returns to step 110 to give the user another opportunity to enter his username and password. If the username and password are not in the member database and the user has no remaining opportunities or if the process only gives the user one opportunity, the process ends. If the username and password entered by the user is found in the member database of the external community, the process continues to step 120.

By entering the correct username and password the user is identified as a member of the external community in step 120. The association of the username for the website and the membership in the external community is stored in the user profile in the user database of the website in step 125. After the user is identified by the website as a member of the external community, the user is able to post information on the website and limit access to the information to other members of the external community who are also registered with the website. In the present embodiment, the user may also protect his identity by using a pseudonym and still be identified as a member of the external community. In alternate embodiments, the website may ask the user to verify the membership in the external community at periodic intervals, such as, but not limited to, once a year, once a month, etc. This would allow the website to restrict users whose memberships have lapsed or been canceled. In some other alternate embodiments, where access to the content in the private area needs to be closely controlled, the website may ask the user to verify the membership in the external community each time he visits the site and requests access to the private areas.

The initial connection script (i.e., program code) of the new user of the website to the external community member database is stored on a server of the website in the present embodiment. However, in alternate embodiments, the initial connection script optionally can be stored on the server of the external community so that the owners of the website at no point in time have access to the actual member database of the external community. Thereby the external community can protect the data of their members from the owners of the website. It will be appreciated by those skilled in the art that multiple external communities may be registered with a website according to the present embodiment. The ability of users of the website to verify themselves as members of registered external communities by entering their pre-existing usernames and passwords stored in the member databases of the external communities in a one-time procedure omits the cumbersome process of distributing electronic tokens as described in the prior art. In alternate embodiments, the website may ask the user to verify the membership in the external community at periodic intervals, such as, but not limited to, once a year, once a month, each time access to private areas is requested, etc. In preferred embodiments of the present invention the user is required to register with the website prior to requesting access to private areas.

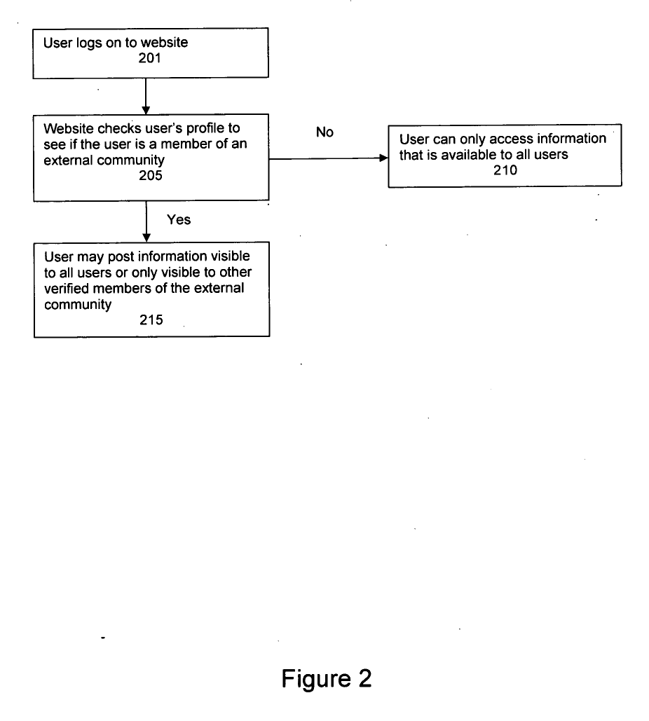

FIG. 2 is a flowchart illustrating an exemplary process of a registered user using a website that enables users to limit access to information posted thereon, in accordance with an embodiment of the present invention. After the verification process is performed for a member of an external community, as described by way of example in accordance with FIG. 1, the member does not need to verify himself as a member of that particular community again since this information is stored in a user profile in a website user database. A user begins using the website by logging onto the website in step 201. Then, in step 205, the user's profile is recalled from the website user database to determine if the user is a member of a registered external community. If the user is not registered as a member of an external community, the user may only access information on the main electronic community that is available to all users in step 210. If the user is registered as a member of an external community the user has the option to view and post information that is openly visible to every user in the main electronic community or to view and post information that is visible only for members of the external community of which he is a member in step 215. Other users of the website who have verified themselves as members of the external community have access to posted information that is limited to members of the external community. For example, without limitation, a member of an external community may post a question on the website for other members of the external community, and in the present embodiment, only other verified members of the external community can see the question and comment on it. In some embodiments the website may only enable registered users who are not members of external communities to access certain limited functions on the website such as, but not limited to, viewing limited areas and viewing and posting in public areas.

In the preferred embodiment, the user can be a member of multiple external communities and can repeat the above procedures, described by way of example in accordance with FIGS. 1 and 2, for all of the communities to which he belongs. The website comprises a profile of the user with all of his memberships. Based on his memberships, the user has access to information posted by other members of the respective communities. Alternate embodiments may be implemented so that users are only able to be verified as users of one external community. For example, without limitation, a company website may provide an electronic forum for the employees of the company to post information. In this website employees may register as members of specific departments of the company and each employee may only register as the member of one department.

An example for the typical use of a preferred embodiment of the present invention is as follows. The main electronic community is a website called showyourcase.com, which is a case discussion forum. The external community is the Orthopedic Trauma Association, and the user is Joe Blow. Joe Blow is a member of the Orthopedic Trauma Association and has a unique username and password for the Orthopedic Trauma Association website, which is stored in an Orthopedic Trauma Association database. Joe Blow signs up for showyourcase.com and creates a user profile.

From within his showyourcase.com profile, Joe Blow verifies himself once as a member of the Orthopedic Trauma Association by entering his Orthopedic Trauma Association username and password. In the present example, the Orthopedic Trauma Association has agreed to allow showyourcase.com to create a connection to the member database of the Orthopedic Trauma Association. The entry form for Joe Blow is connected to the Orthopedic Trauma Association member database and the system determines whether the entered username and password is correct. If the entered username and password is correct, Joe Blow is marked as an Orthopedic Trauma Association member in the showyourcase.com user database. From now on when Joe Blow logs on to showyourcase.com, he will be recognized as an Orthopedic Trauma Association member and will be able to post and view information on showyourcase.com that is only visible to other showyourcase.com users who are verified Orthopedic Trauma Association members.

In some embodiments, the website may comprise “nested” multi-level hierarchical external communities. In these embodiments, the external communities are organized in a hierarchical manner and access rights to information are granted based on the membership to an external community such as, but not limited to, a professional organization or a company and on membership to a higher level network to which the external community belongs.

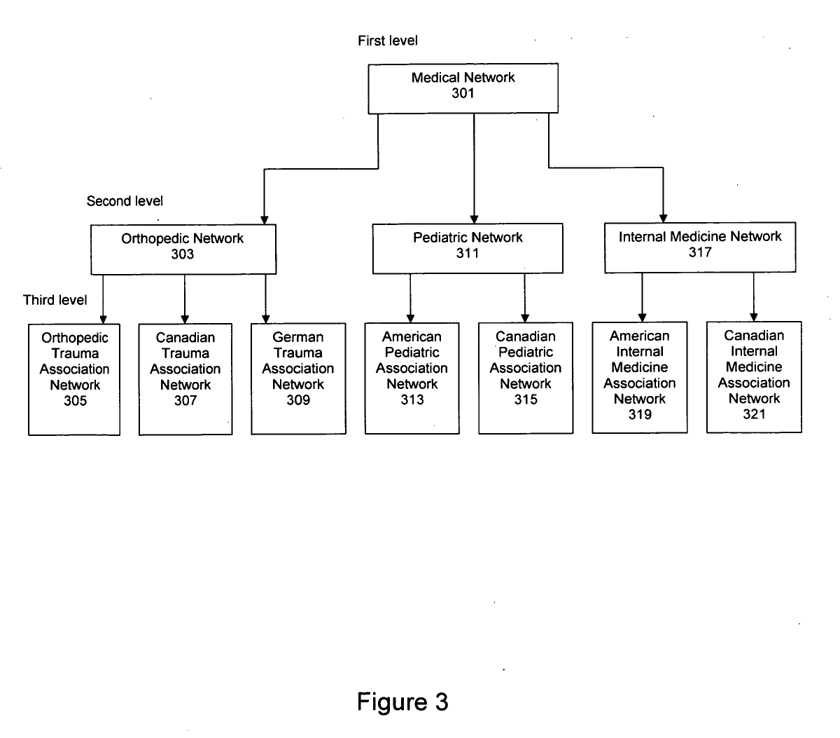

FIG. 3 is a block diagram illustrating an exemplary network structure of external communities in a multi-level hierarchical system, in accordance with an embodiment of the present invention. In the present example, a 1^{st} level network, a Medical network 301, comprises multiple lower level networks. A 2^{nd} level network, an orthopedic network 303, comprises multiple 3^{rd} level networks: an Orthopedic Trauma Association network 305, a Canadian Orthopedic Association network 307 and a German Orthopedic Association network 309. A 2^{nd} level network, a pediatric network 311, comprises multiple 3^{rd} level networks: an American Pediatric Association network 313 and a Canadian Pediatric Association network 315. Finally, a 2^{nd} level network, an internal medicine network 317, comprises two 3^{rd} level networks, an American Internal Medicine Association network 319 and a Canadian Internal Medicine Association network 321. Those skilled in the art, in light of the present teachings, will readily recognize that the lower levels of the hierarchy may comprise more or fewer networks in alternate examples. Furthermore, the number of levels that can be placed in a hierarchical structure is essentially unlimited.

In the present embodiment, users who are verified as a network member at a certain level are automatically members of any higher level network. For example, without limitation, a user who is verified as a member of Canadian Orthopedic Association network 307 is also verified as a member of orthopedic network 303 and medical network 301, and a user who is verified as a member of pediatric network 311 is also verified as a member of medical network 301, while a user who is verified as a member of medical network 301 is only a member of medical network 301. The network structure is typically established by the provider of the website and disclosed to the users. However, in some instances the hierarchy may be established by the community members and disclosed to the website provider.

In typical use of the network structure in the present example, a user who is a member of Orthopedic Trauma Association network 305 posts information on the website and can decide if he wants to post the information in Orthopedic Trauma Association network 305, in the higher level associated orthopedic network 303 or even one level up in medical network 301. If the user posts the information in Orthopedic Trauma Association network 305, only members of the Orthopedic Trauma Association have access to the information. If the user posts the information in orthopedic network 303, any verified member of any lower level network associated with orthopedic network 303 has access to the information. In this example the information is available to Orthopedic Trauma Association network 305, Canadian Orthopedic Association network 307 and German Orthopedic Association network 309. If the user posts the information on medical network 301, any member of any associated lower lever network has access to the posted information.

In the present embodiment, the verification process of a member can occur at any level, for example, without limitation, on the 3^{rd} level if the user is a member of any of the 3^{rd} level network organizations or on the 1^{st} level if the user is a licensed physician. A user is automatically a member of any higher level network relative to the level in which he is verified.

In other embodiments, rather than being organized in a hierarchical or one-to-many relationship structure where there is one 1^{st} level network and multiple associated lower-level networks as shown by way of example in FIG. 3, networks may be related to each other in many-to-many, or non-hierarchical relationships. This is an analogy to database design structures.

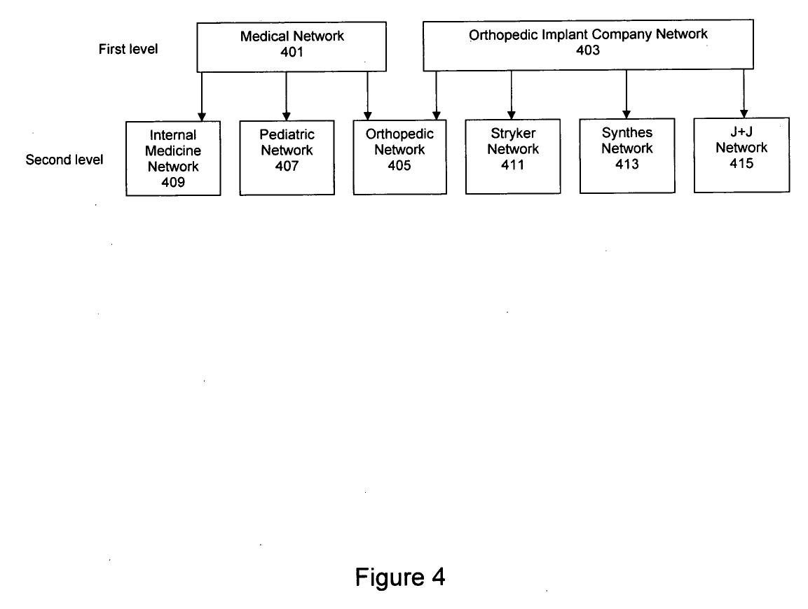

FIG. 4 is a block diagram illustrating an exemplary network structure of external communities in a many-to-many relationship system, in accordance with an embodiment of the present invention. In the present example, 1st level networks include a medical network 401 and an orthopedic implant company network 403. Medical network 401 comprises the following 2nd level networks: an orthopedic network 405, a pediatric network 407 and an internal medicine network 409. Orthopedic implant company network 403 comprises the following 2nd level networks: orthopedic network 405, Stryker network 411, Synthes network 413, and J&J network 415.

A many-to-many relationship means that a lower-level network can be a member of more than one upper-level network. In the present example orthopedic network 405 is a member of medical network 401 and orthopedic implant company network 403. As in the previous example, users who are verified as a network member at a certain level are automatically members of any higher level network. For example, without limitation, a user who is verified as a member of pediatric network 407 is also a member of medical network 401, a user who is verified as a member of medical network 401 is only a member of medical network 401 and a user who is verified as a member of orthopedic network 405 is also a member of both medical network 401 and orthopedic implant company network 403. Those skilled in the art, in light of the present teachings, will readily recognize that the different levels of the network structure may comprise more or fewer networks in alternate examples. Furthermore, the number of levels that can be placed in a many-to-many network structure is essentially unlimited.

Alternate embodiments of the present invention may use various different community and network structures, other than the structures illustrated by way of example in FIGS. 3 and 4. For example, without limitation, additional sublevels to the shown lower-levels.

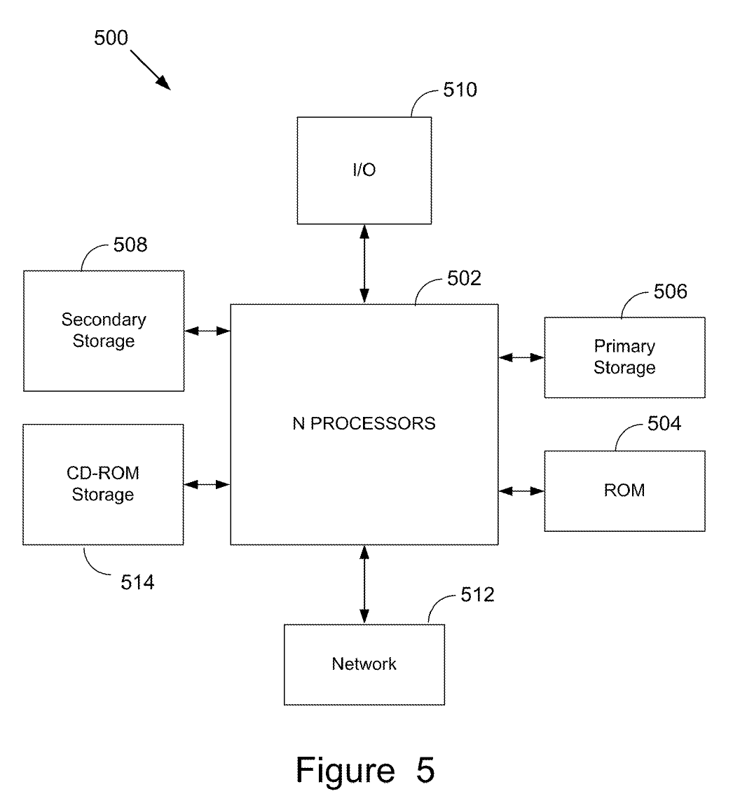

FIG. 5 illustrates a typical computer system that, when appropriately configured or designed, can serve as a computer system in which the invention may be embodied. The computer system 500 includes any number of processors 502 (also referred to as central processing units, or CPUs) that are coupled to storage devices including primary storage 506 (typically a random access memory, or RAM), primary storage 504 (typically a read only memory, or ROM). CPU 502 may be of various types including microcontrollers (e.g., with embedded RAM/ROM) and microprocessors such as programmable devices (e.g., RISC or SISC based, or CPLDs and FPGAs) and unprogrammable devices such as gate array ASICs or general purpose microprocessors. As is well known in the art, primary storage 504 acts to transfer data and instructions uni-directionally to the CPU and primary storage 506 is used typically to transfer data and instructions in a bi-directional manner. Both of these primary storage devices may include any suitable computer-readable media such as those described above. A mass storage device 508 may also be coupled bi-directionally to CPU 502 and provides additional data storage capacity and may include any of the computer-readable media described above. Mass storage device 508 may be used to store programs, data and the like and is typically a secondary storage medium such as a hard disk. It will be appreciated that the information retained within the mass storage device 508, may, in appropriate cases, be incorporated in standard fashion as part of primary storage 506 as virtual memory. A specific mass storage device such as a CD-ROM 514 may also pass data uni-directionally to the CPU.

CPU 502 may also be coupled to an interface 510 that connects to one or more input/output devices such as such as video monitors, track balls, mice, keyboards, microphones, touch-sensitive displays, transducer card readers, magnetic or paper tape readers, tablets, styluses, voice or handwriting recognizers, or other well-known input devices such as, of course, other computers. Finally, CPU 502 optionally may be coupled to an external device such as a database or a computer or telecommunications or internet network using an external connection as shown generally at 512, which may be implemented as a hardwired or wireless communications link using suitable conventional technologies. With such a connection, it is contemplated that the CPU might receive information from the network, or might output information to the network in the course of performing the method steps described in the teachings of the present invention.

Those skilled in the art will readily recognize, in accordance with the teachings of the present invention, that any of the foregoing steps and/or system modules may be suitably replaced, reordered, removed and additional steps and/or system modules may be inserted depending upon the needs of the particular application, and that the systems of the foregoing embodiments may be implemented using any of a wide variety of suitable processes and system modules, and is not limited to any particular computer hardware, software, middleware, firmware, microcode and the like.

It will be further apparent to those skilled in the art that at least a portion of the novel method steps and/or system components of the present invention may be practiced and/or located in location(s) possibly outside the jurisdiction of the United States of America (USA), whereby it will be accordingly readily recognized that at least a subset of the novel method steps and/or system components in the foregoing embodiments must be practiced within the jurisdiction of the USA for the benefit of an entity therein or to achieve an object of the present invention. Thus, some alternate embodiments of the present invention may be configured to comprise a smaller subset of the foregoing novel means for and/or steps described that the applications designer will selectively decide, depending upon the practical considerations of the particular implementation, to carry out and/or locate within the jurisdiction of the USA. For any claims construction of the following claims that are construed under 35 USC §112 (6) it is intended that the corresponding means for and/or steps for carrying out the claimed function also include those embodiments, and equivalents, as contemplated above that implement at least some novel aspects and objects of the present invention in the jurisdiction of the USA. For example, the website may be performed and/or located outside of the jurisdiction of the USA while the remaining method steps and/or system components of the forgoing embodiments are typically required to be located/performed in the US for practical considerations.

Having fully described at least one embodiment of the present invention, other equivalent or alternative methods of limiting access to information and/or certain functions in an electronic community based on membership in an external community according to the present invention will be apparent to those skilled in the art. The invention has been described above by way of illustration, and the specific embodiments disclosed are not intended to limit the invention to the particular forms disclosed. For example, the particular implementation of the limiting means may vary depending upon the particular type of electronic community used. The electronic communities described in the foregoing were directed to internet based implementations; however, similar techniques are to provide limiting means for electronic communities in smaller networks such as, but not limited to, local area networks (LAN), campus area networks (CAN), metropolitan area networks (MAN), wide area networks (WAN), etc. Non-internet based implementations of the present invention are contemplated as within the scope of the present invention. The invention is thus to cover all modifications, equivalents, and alternatives falling within the spirit and scope of the following claims.

What is claimed is:

1. A method for membership based access over a network, the method comprising:
steps for accessing an electronic community having at least one private area for members of an external electronic community;
steps for requesting information access to said private area; and
steps for supplying at least one unique identifier for verifying a membership in said external electronic community using a connection with said external electronic community.

2. The method as recited in claim 1, further comprising steps for logging into said electronic community for said information access to said private area, wherein stored membership verification enables information access to said private area.

3. The method as recited in claim 1, further comprising steps for enabling information access to a level of said private area comprising a multi-level hierarchical organization, and to higher levels.

4. A method for membership based access over a network, the method comprising steps of:
accessing an electronic community where said electronic community has established at least one private area for members of an external electronic community and a connection with said external electronic community;
requesting information access to said private area; and
supplying at least one unique identifier associated with a membership in said external community for membership verification and storage of said membership verification, where said connection is used to verify said unique identifier with said external electronic community.

5. The method as recited in claim 4, further comprising the step of logging into said electronic community for said information access to said private area by supplying login information for comparison to stored membership verification to enable information access to said private area.

6. The method as recited in claim 4, wherein said electronic community has further established at least one public area in which information access is available to all registered users of said electronic community.

7. The method as recited in claim 4, wherein said stored membership verification at least comprises a membership status.

8. The method as recited in claim 5, wherein said login information obtained during said logging at least comprises a username for said electronic community.

9. The method as recited in claim 4, wherein said private area comprises a multi-level hierarchical organization for members of related external electronic communities.

10. The method as recited in claim 9, wherein a user with verified membership at a one of said related electronic communities is enabled with information access to a level of said private area associated with said one of said related electronic communities and to other higher levels.

11. A system for membership based access over a network, the system comprising:
means for maintaining identities of a plurality of registered members; and
means for establishing at least one private area for registered members of said maintaining means and a connection with said maintaining means, wherein registered users request information access to said private area by supplying at least one unique identifier for verifying a membership, and said establishing means uses said connection to verify said at least one unique identifier with said maintaining means, and stores membership verification for said registered users.

12. The system as recited in claim 11, further comprising means for enabling registered users for information access to said private area.

13. The system as recited in claim 11, further comprising means for enabling information access to a level of said private area comprising a multi-level hierarchical organization, and to higher levels.

14. A system for membership based access over a network, the system comprising:
an external electronic community comprising a plurality of registered members, wherein said external electronic community maintains a database of identities of said plurality of registered members; and
an electronic community where said electronic community has established at least one private area for registered members of said external electronic community and a connection with said external electronic community, wherein registered users of said electronic community request information access to said private area by supplying at least one unique identifier associated with a membership in said external community for verifying said membership in said external electronic community, and said electronic community uses said connection to verify said unique identifier with said external electronic community, and stores membership verification for said registered users.

15. The system as recited in claim 14, wherein said registered users of said electronic community log into said electronic community for said information access to said private area, and said electronic community compares login information obtained during said logging to said stored membership verification to enable information access to said private area.

16. The system as recited in claim 14, wherein said electronic community has further established at least one public area in which information access is available to all registered users of said electronic community.

17. The system as recited in claim 14, wherein said stored membership verification at least comprises a membership status.

18. The system as recited in claim 15, wherein said login information obtained during said logging at least comprises a username for said electronic community.

19. The system as recited in claim 14, wherein said private area comprises a multi-level hierarchical organization for registered members of related external electronic communities.

20. The system as recited in claim 19, wherein said registered users with verified membership at a one of said related electronic communities is enabled with information access to a level of said private area associated with said one of said related electronic communities and to other higher levels.

21. A computer program product for membership based access over a network, the computer program product comprising:
computer program code for accessing an electronic community where said electronic community has established at least one private area for members of an external electronic community and a connection with said external electronic community;
computer program code for requesting information access to said private area;
computer program code for supplying at least one unique identifier associated with a membership in said external community for membership verification and storage of said membership verification, where said connection is used to verify said unique identifier with said external electronic community; and
a computer-readable medium storing the computer program code.

22. The computer program product as recited in claim 21, further comprising computer program code for logging into said electronic community for said information access to said private area by supplying login information for comparison to stored membership verification to enable information access to said private area.

23. The computer program product as recited in claim 21, wherein said electronic community has further established at least one public area in which information access is available to all registered users of said electronic community.

24. The computer program product as recited in claim 21, wherein said stored membership verification at least comprises a membership status.

25. The computer program product as recited in claim 22, wherein said login information obtained during said logging at least comprises a username for said electronic community.

26. The computer program product as recited in claim 21, wherein said private area comprises a multi-level hierarchical organization for members of related external electronic communities.

27. The computer program product as recited in claim 26, wherein a user with verified membership at a one of said related electronic communities is enabled with information access to a level of said private area associated with said one of said related electronic communities and to other higher levels.
